(19) United States
(12) Patent Application Publication
(10) Pub. No.: US 2022/0072571 A1
(43) Pub. Date: Mar. 10, 2022

(54) Sprayer for Providing a Helical Spray

(71) Applicant: ZHANGZHOU LEYUAN INDUSTRIAL CO., LTD., Zhangzhou City (CN)

(72) Inventor: Wen-Li Kuo, Zhangzhou City (CN)

(21) Appl. No.: 17/015,620

(22) Filed: Sep. 9, 2020

(51) Int. Cl. B05B 3/04

(52) U.S. Cl. CPC B05B 3/0418; B05B 1/1645

(57) ABSTRACT

A sprayer includes a nozzle that includes a panel, an operation chamber and an outlet element. The outlet element includes an external tube, internal tubes and outlets. The external tube extends in the operation chamber from the panel. The internal tubes extend in the external tube from the panel. Each internal tube includes tangential passageways. The outlets are made in the panel, in communication with the internal tubes. The distributor is inserted in the operation chamber and includes a disc and an inlet element. The inlet element includes a cylinder, inlets and protuberances. The cylinder extends into the external tube from the disc. The inlets are made in the cylinder. Interior of the cylinder is in communication with exterior of the cylinder via the inlets. The protuberances are formed on the cylinder and inserted in the internal tubes. The barrel includes a water supply tube connected to the inlet element.

### BACKGROUND OF INVENTION

### 1. Field of Invention

The present invention relates to a sprayer and, more particularly, to a sprayer for providing a helical spray.

### 2. Related Prior Art

Sprayers are often used in gardening. Various sprayers have been devised to provide different patterns of sprays. For example, U.S. Pat. No. 9,630,191 issued to the present applicant discloses a conventional sprayer that includes a surface cover 1, a water distribution member 2 and a body 3. The surface cover 1 is formed with multiple orifices 11. The internal side of the surface cover 1 is formed with multiple annular flanges 12 corresponding to the orifices 11. Each flange 12 is formed with two tangential openings 13 tangent to an internal wall 14 of the flange 12. In use, water goes into the body 3 via an inlet. Then, the water goes into the surface cover 1 from the body 3 via multiple holes 21 of the water distribution member 2. Then, a portion of the water enters each flange 12 via the two tangential openings 13 in two streams to form a whirlpool. Finally, the water is sprayed from the orifices 11.

However, several problems have been encountered in the operation of the conventional sprayer. Firstly, the streams interfere with each other in each flange 12 so that a water swirl in each flange 12 is reduced. Hence, the range of the spray from the orifices 11 is small.

Secondly, the surface cover 1 is often merged with the water distribution member 2 via ultrasonic waves. Hence, they cannot be taken from each other to remove undesired substances once such undesired substances enter them. The tangential openings 13, space in the flanges 12 or the orifices 11 could be jammed and the effect of the spraying could be reduced.

Thirdly, the orifices 11 of the surface cover 1 must be aligned with the holes 21 of the water distribution member 2 before the surface cover 1 is connected to the water distribution member 2. This is a troublesome practice.

The present invention is therefore intended to obviate or at least alleviate the problems encountered in the prior art.

### SUMMARY OF INVENTION

It is the primary objective of the present invention to provide a sprayer for effectively providing a helical spray.

To achieve the foregoing objective, the sprayer includes a nozzle, a distributer and a barrel. The nozzle includes a panel, an operation chamber and an outlet element. The outlet element includes an external tube, multiple internal tubes and multiple outlets. The external tube extends into the operation chamber from the panel. The internal tubes extend into the external tube from the panel. Each of the internal tubes includes multiple tangential passageways. The outlets are made in the panel, respectively in communication with the internal tubes. The distributor is inserted in the operation chamber and includes a disc and an inlet element. The inlet element includes a cylinder, multiple inlets and multiple protuberances. The cylinder extends into the external tube from the disc. The inlets are made in the cylinder so that interior of the cylinder is in communication with exterior of the cylinder via the inlets. The protuberances are formed at an end of the cylinder and respectively inserted in the internal tubes. The barrel includes a water supply tube connected to the inlet element.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a sprayer according to the preferred embodiment of the present invention;

FIG. 2 is an exploded view of the sprayer shown in FIG. 1;

FIG. 3 is another exploded view of the sprayer than FIG. 2;

FIG. 4 is a cross-sectional view of the sprayer shown in FIG. 1;

FIG. 5 is a partial view of the sprayer shown in FIG. 2;

FIG. 6 is a partial view of the sprayer shown in FIG. 5;

FIG. 7 is a partial view of the sprayer shown in FIG. 6;

FIG. 8 is another partial view of the sprayer than FIG. 7;

FIG. 9 is a cut-away view of a portion of the sprayer shown in FIG. 6;

FIG. 10 is a partial view of the sprayer shown in FIG. 1;

FIG. 11 is a cut-away view of the sprayer shown in FIG. 10;

FIG. 12 is another cut-away view of the sprayer than FIG. 11;

FIG. 13 is another cut-away view of the sprayer than FIG. 12;

FIG. 14 is a cross-sectional view of the sprayer shown in FIG. 11;

FIG. 15 is a cross-sectional view of the sprayer taken along a line A-A shown in FIG. 14; and

FIG. 16 is a cross-sectional view of the sprayer taken along a line B-B shown in FIG. 5.

### DETAILED DESCRIPTION OF PREFERRED EMBODIMENT

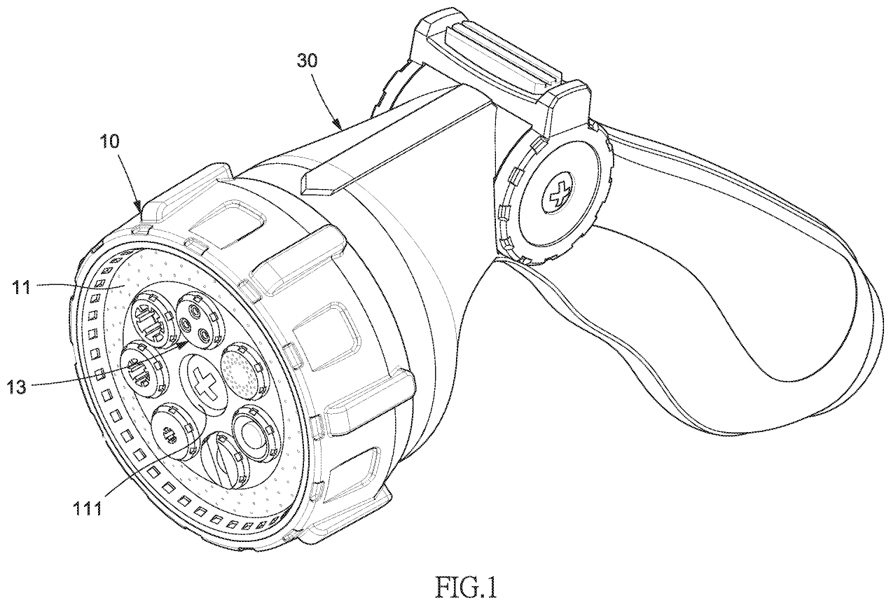

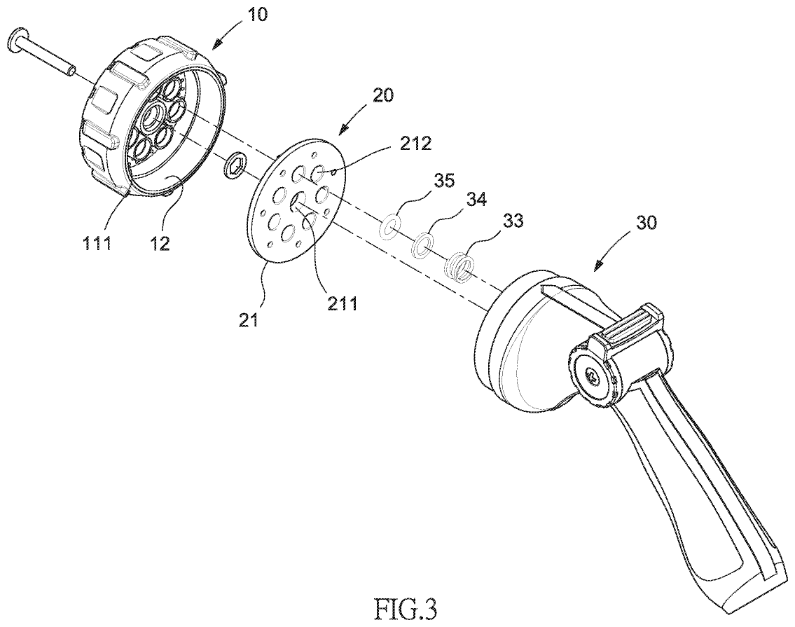

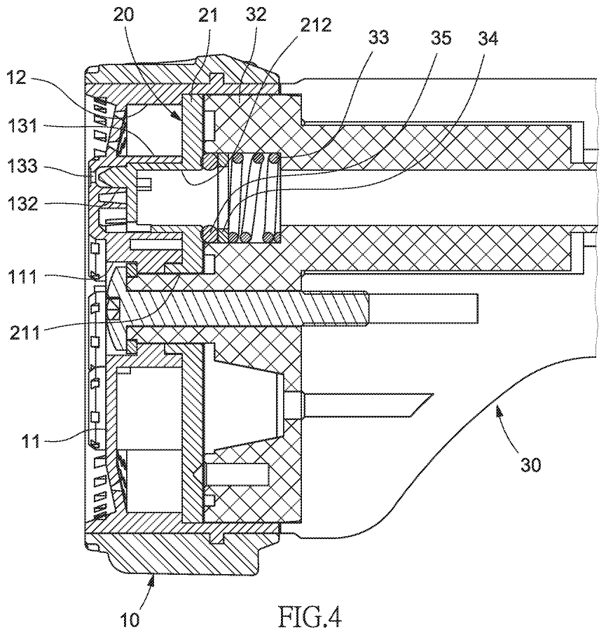

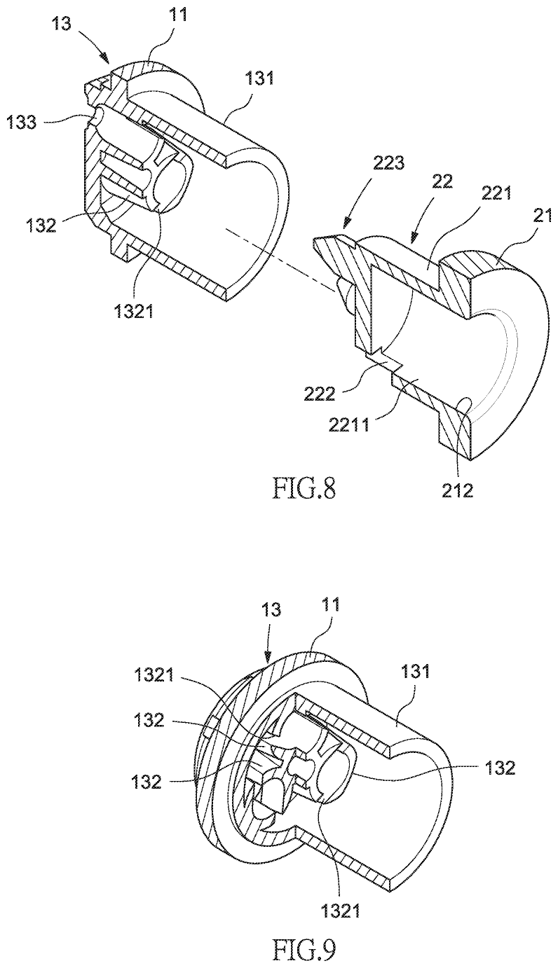

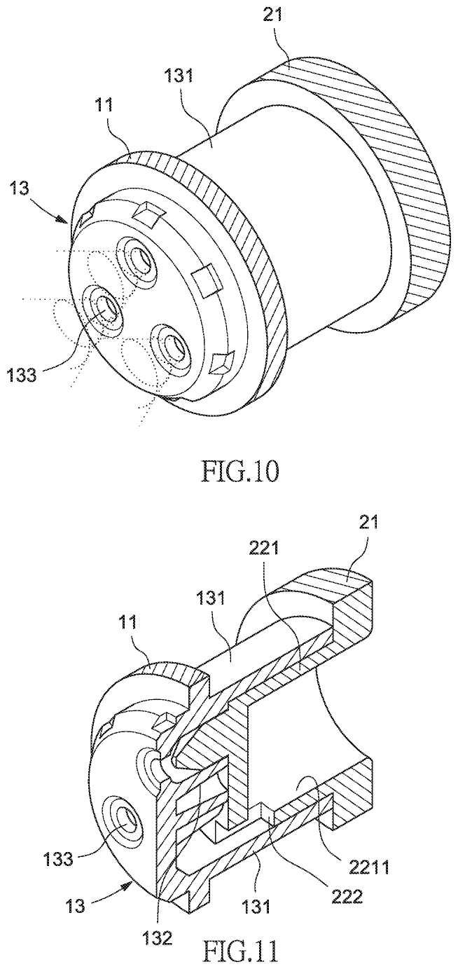

Referring to FIGS. 1 through 10, a sprayer for providing a helical spray includes a nozzle 10, a distributor 20 and a barrel 30 according to the preferred embodiment of the present invention.

Referring to FIGS. 1 through 5, the nozzle 10 includes a panel 11, an operation chamber 12 and preferably multiple outlet elements 13. The panel 11 and the operation chamber 12 are located at two opposite ends of the nozzle 10. The panel 11 includes a central orifice 111 in communication with the operation chamber 12. The panel 11 and the operation chamber 12 will not be described in detail for being conventional.

Referring to FIGS. 5 through 9, the outlet elements 13 are formed on the panel 11. The outlet elements 13 are in various shapes. One of the outlet elements 13 includes an external tube 131, multiple internal tubes 132 and multiple outlets 133.

The external tube 131 extends in the operation chamber 12 from a rear face of the panel 11.

The internal tubes 132 also extend from the rear face of the panel 11. The internal tubes 132 are located in the external tube 131. Each of the internal tubes 132 includes two tangential passageways 1321 respectively in two opposite portions of the periphery of the internal tube 132 Interior of each of the internal tubes 132 is in communication with exterior of the internal tube 132 via the tangential passageways 1321. The tangential passageways 1321 are made in compliance with the curvature of the corresponding internal tube 132.

Each of the outlets 133 is in communication with a corresponding one of the internal tubes 132. The internal tubes 132 are in communication with exterior of the nozzle 10 via the outlets 133.

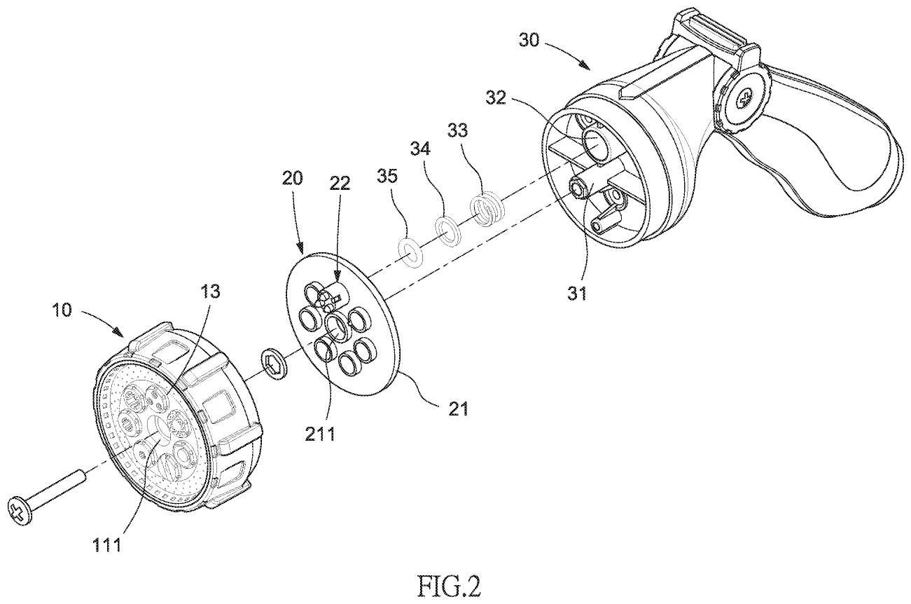

Referring to FIGS. 2 through 5, the distributor 20 is inserted in the operation chamber 12 of the nozzle 10. The distributor 20 includes a disc 21 and preferably multiple inlet elements 22 although only one of the inlet elements 22 is shown.

The disc 21 is shaped in compliance with the of the operation chamber 12 of the nozzle 10. The disc 21 is formed with a central orifice 211 and preferably multiple orifices 212. The central orifice 211 of the disc 21 is aligned with the central orifice 111 of the panel 11. The orifices 212 are located around the central orifice 211.

Referring to FIGS. 2 and 4 through 8, the inlet elements 22 are formed on a front face of the disc 21. Each of the inlet elements 22 is in communication with a corresponding one of the orifices 212. Each of the inlet elements 22 includes a cylinder 221, multiple inlets 222 and multiple protuberances 223.

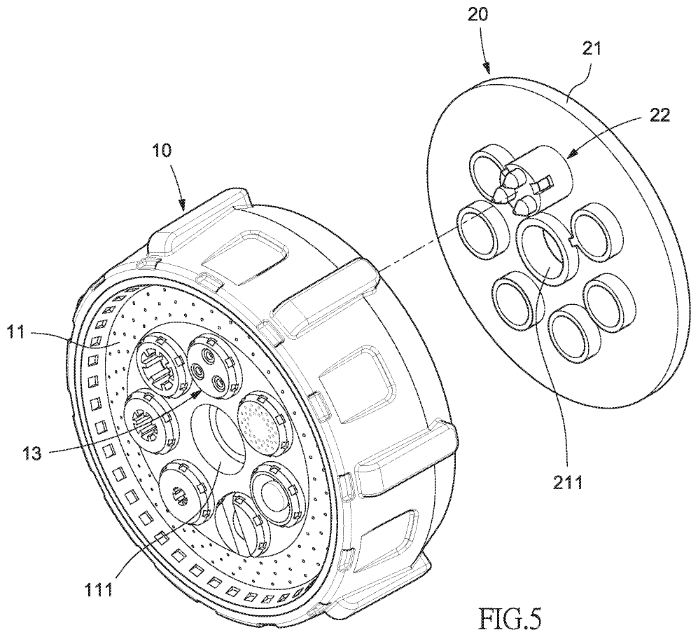

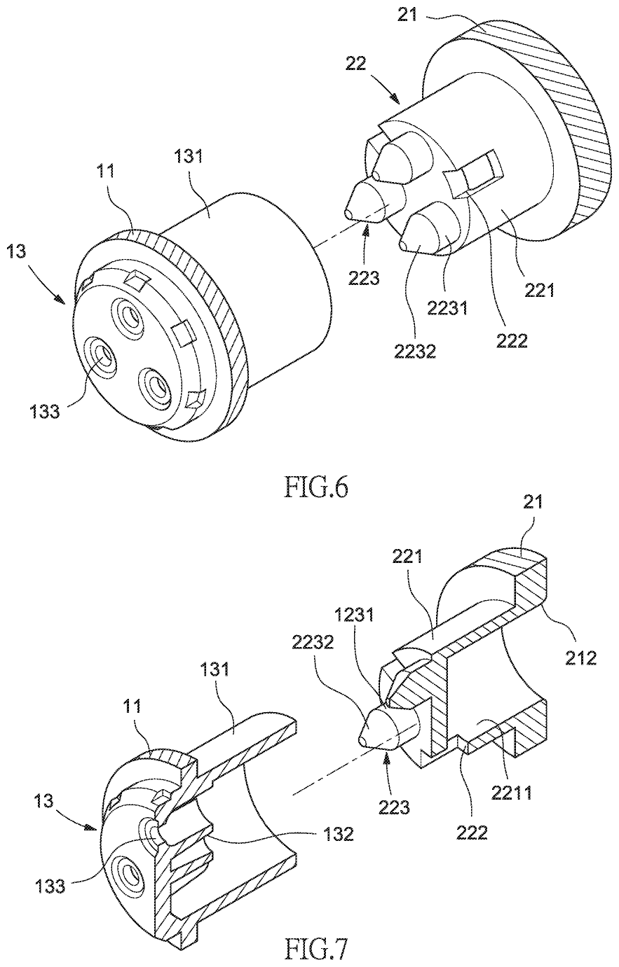

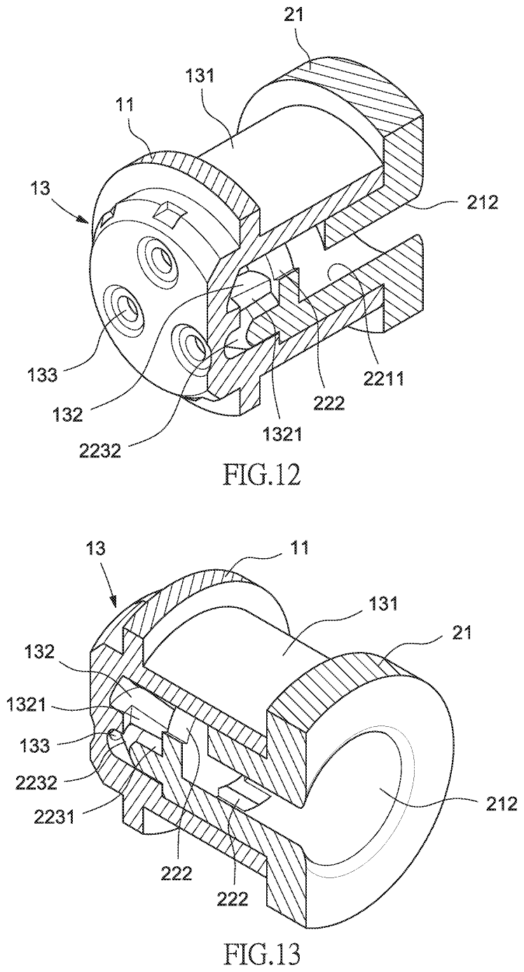

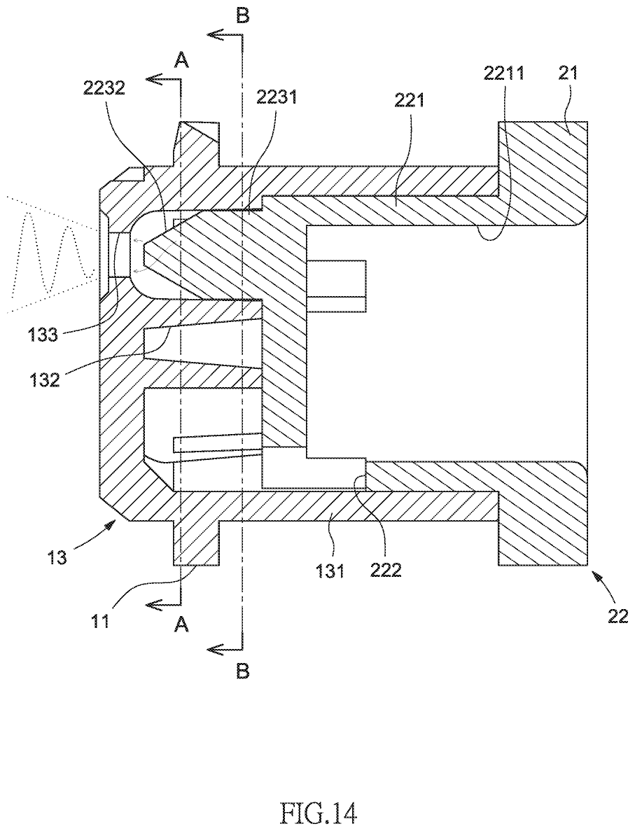

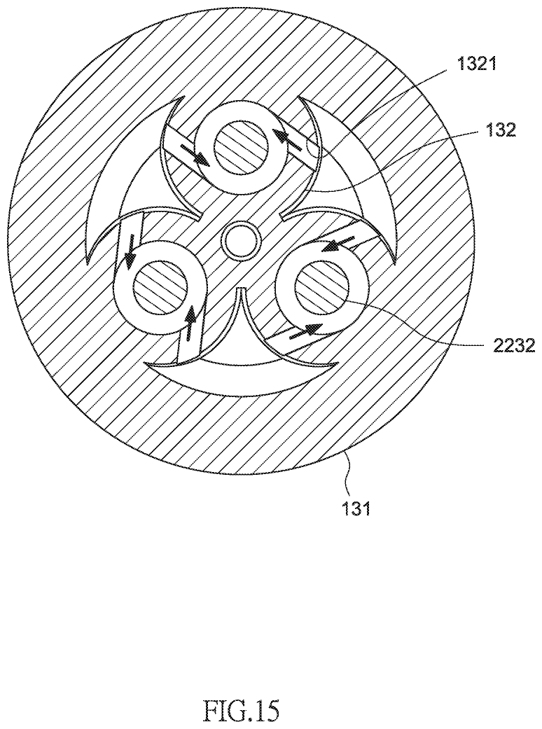

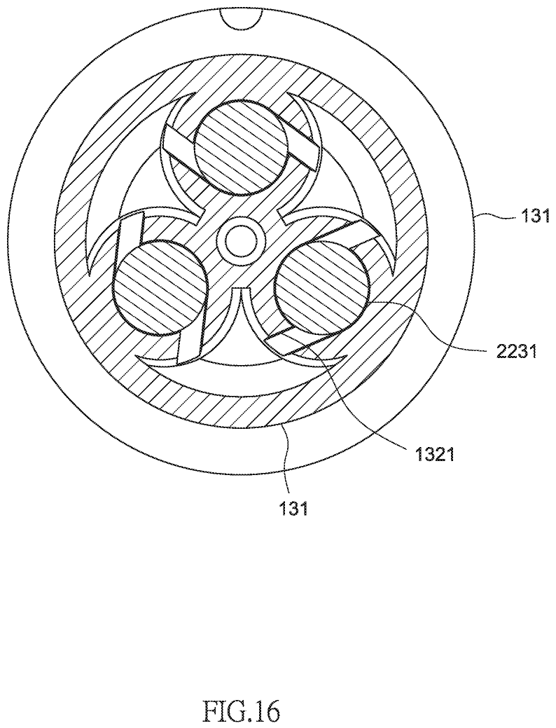

The cylinder 221 extends from the front face of the disc 21. The cylinder 221 is shaped corresponding to the external tube 131. The cylinder 221 includes a space 2211 in communication with the orifices 212. Referring to FIGS. 6 and 10 through 16, the cylinder 221 of each of the inlet elements 22 is inserted in the external tube 131 of a corresponding one of the outlet elements 13.

Referring to FIGS. 6, 7 and 11 through 13, the inlets 222 are made in the periphery of the cylinder 221. The inlets 222 are in communication with the space 2211 of the cylinder 221.

The protuberances 223 are formed at an end of the cylinder 221. Each of the protuberances 223 includes a cylindrical section 2231 and a conical section 2232. Each of the protuberances 223 is inserted in a corresponding one of the internal tubes 132.

Referring to FIGS. 1 through 4, the barrel 30 includes an axial sleeve 31, a water supply tube 32 and a spring 33, a washer 34 and an O-ring 35.

The axial sleeve 31 extends from an end of the barrel 30. The axial sleeve 31 is co-axially inserted in the central orifice 111 and the central orifice 211 so that the axial sleeve 31 is connected to the nozzle 10 (the panel 11) and the distributor 20 (the disc 21). A threaded bolt (not numbered) is inserted in a screw hole made in the axial sleeve 31 to keep the nozzle 10 and the distributor 20 on axial sleeve 31 of the barrel 30. The water supply tube 32 of the barrel 30 is in contact with a rear face of the distributor 20. The nozzle 10 and the distributor 20 are rotatable relative to the barrel 30 to bring a selected one of the orifices 212 of the distributor 20 into communication with the water supply tube 32.

Referring to FIGS. 1 through 4 and 12 through 14, the nozzle 10 and the distributor 20 are rotated together relative to the barrel 30 to bring a selected one of the inlet elements 22 (or the orifices 212) of the distributor 20 into communication with the water supply tube 32. Water goes into the space 2211 of the cylinder 221 of the selected inlet element 22 (or the selected orifice 212) of the distributor 20 from the water supply tube 32. Then, the water goes into the external tube 131 of the selected outlet element 13 through the inlets 222 of the cylinder 221 of the selected inlet element 22.

Referring to FIGS. 11 through 16, the water goes into each of the internal tubes 132 in two streams from the external tube 131 via the tangential passageways 1321 of the internal tubes 132. The tangential passageways 1321 extend in tangential directions of an internal face of each of the internal tubes 132 so that the water is turned into a whirlpool the internal tube 132. The conical section 2232 of each of the protuberances 223 separates the streams from each other in the corresponding internal tube 132, i.e., the streams do not interfere with each other in the internal tube 132. Then, the conical section 2232 of each of the protuberances 223 guides the water out of the corresponding outlet 133 of the selected outlet element 13. Thus, a strong helical spray goes out of each of the outlets 133 of each of the outlet elements 13.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A sprayer for providing a helical spray comprising:
a nozzle (10) comprising a panel (11), an operation chamber (12) located opposite to the panel (11), and an outlet element (13) comprising:
an external tube (131) extending into the operation chamber (12) from the panel (11);
multiple internal tubes (132) extending into the external tube (131) from the panel (11), wherein each of the internal tubes (132) comprises multiple tangential passageways (1321);
multiple outlets (133) made in the panel (11), respectively in communication with the internal tubes (132);
a distributor (20) inserted in the operation chamber (12) and formed with a disc (21) and an inlet element (22) comprising:
a cylinder (221) extending into the external tube (131) from the disc (21) and comprising a space (2211);
multiple inlets (222) made in the cylinder (221) so that the space (2211) of the cylinder (221) is in communication with exterior of the cylinder (221) via the inlets (222); and
multiple protuberances (223) formed at an end of the cylinder (221) and respectively inserted in the internal tubes (132); and
a barrel (30) comprising a water supply tube (32) connected to the inlet element (22).

2. The sprayer according to claim 1, wherein each of the protuberances (223) comprises a cylindrical section (2231) and a conical section (2232) formed at an end of the cylindrical section (2231).

3. The sprayer according to claim 1, wherein the panel (11) comprises a central orifice (111), wherein the disc (21) comprises a central orifice (211) aligned to the central orifice (111) of the panel (11), wherein the barrel (30) comprises an axial sleeve (31) inserted in the central orifice (111) of the panel (11) and the central orifice (211) of the disc (21).

4. The sprayer according to claim 1, wherein each of the tangential passageways (1321) extends in a tangential direction of an internal face of each of the internal tubes (132).

5. The sprayer according to claim 1, further comprising a spring (33), a washer (34) and an O-ring (35) inserted in the water supply tube (32).
